(19) United States
(12) Patent Application Publication
(10) Pub. No.: US 2016/0140299 A1
(43) Pub. Date: May 19, 2016

(54) AUTO DIRECTOR FOR THE AMBULANCE AND EMERGENCY

(71) Applicant: UMM Al-Qura University, Makkah (SA)

(72) Inventor: Tariq Lahi AL HARBI, Taif (SA)

(73) Assignee: UMM Al-Qura University, Makkah (SA)

(21) Appl. No.: 14/404,100

(22) PCT Filed: Nov. 17, 2014
(86) PCT No.: PCT/IB2014/002462

§ 371 Date: Nov. 26, 2014

(51) Int. Cl. G06F 19/00

(52) U.S. Cl. CPC G06F 19/327

(57) ABSTRACT

An emergency response system includes at least one server with circuitry configured to receive an emergency report from an external device regarding injuries and location of at least one victim. A scope of the emergency is determined based on the emergency report that describes a location of the victim and the injuries of the victim. The circuitry outputs instructions to the external device related to providing first aid based on the injuries of the victim. At least one emergency response team is assigned to respond to the emergency, and information related to one or more incoming patients is output to a medical facility.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

The first minutes after medical emergencies occur are often the most critical moments for casualty response in order to save the life of a victim. In many cases, bystanders with little to no medical expertise are among the first people to encounter the victim and may not know how to provide first aid to lessen the negative impacts of the injuries.

### SUMMARY

In an exemplary embodiment, an emergency response system includes at least one server with circuitry configured to receive an emergency report from an external device regarding injuries and location of at least one victim. A scope of the emergency is determined based on the emergency report that describes a location of the victim and the injuries of the victim. The circuitry outputs instructions to the external device related to providing first aid based on the injuries of the victim. At least one emergency response team is assigned to respond to the emergency, and information related to one or more incoming patients is output to a medical facility.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary illustration of an emergency response system, according to certain embodiments;

FIG. 2 is an exemplary flowchart of an emergency response process, according to certain embodiments;

FIG. 3 is an exemplary illustration of factors affecting an emergency scope determination, according to certain embodiments;

FIG. 4 is an exemplary illustration of a display of the triage apparatus, according to certain embodiments;

FIG. 5 is an exemplary flowchart of a first responder assistance process, according to certain embodiments;

FIGS. 6A-6C illustrate screens on the mobile device 112 for the first responder to input the emergency information, according to certain embodiments;

FIG. 7 is an illustration of an exemplary screen 700 providing first aid guidance to the first responder, according to certain embodiments;

FIG. 8 is an exemplary flowchart of an emergency response team assignment, according to certain embodiments;

FIG. 9 illustrates a non-limiting example of a server for an emergency response system, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise. The drawings are generally drawn to scale unless specified otherwise or illustrating schematic structures or flowcharts.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system for responding to emergency situations, such as medical emergencies, severe weather, natural disasters, and the like. For example, when one or more victims suffer life-threatening injuries, an emergency response system can be used to report the incident and assist one or more first responders to provide first aid to the victims until emergency medical personnel arrive at the scene of the emergency. In addition, the emergency response system allows emergency response centers to prioritize responses to a plurality of emergencies based on severity, location of one or more emergency response vehicles, and the like. The emergency response system can also issue driving directions to the emergency response vehicles and provide medical professionals with information about patients who will be arriving at a medical facility, such as a hospital emergency room, for medical care.

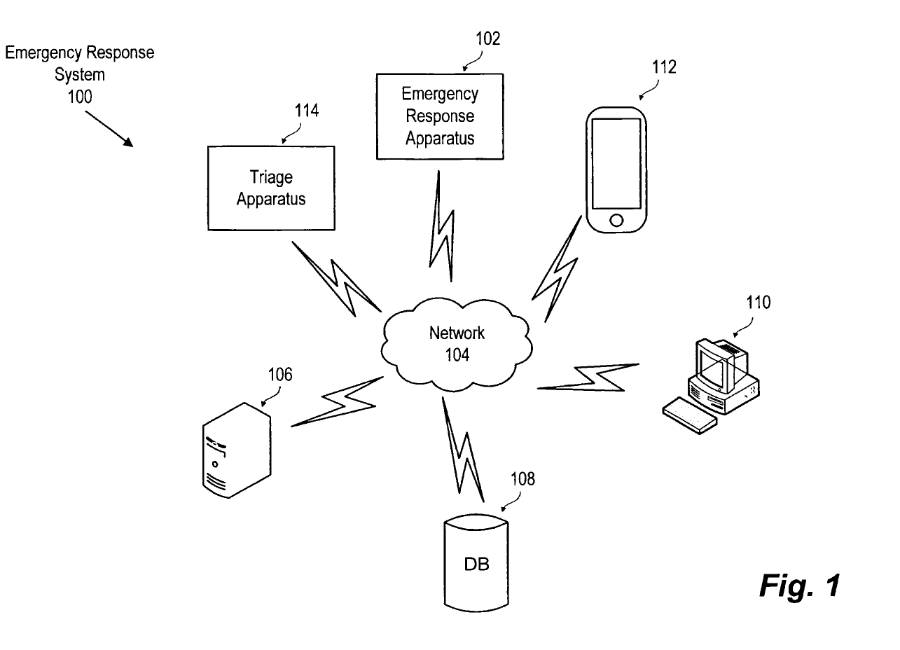

FIG. 1 is an exemplary illustration of an emergency response system 100, according to certain embodiments. At least one emergency response apparatus 102 and at least one triage apparatus 114 are connected to a server 106, database 108, computer 110, and mobile device 112 via a network 104. The emergency response apparatus 102 is an external device, such as a Smart Phone, tablet, laptop, and the like, that includes position-determination circuitry, such as a global positioning system (GPS) receiver in order to provide directions to the emergency response personnel travelling to the scene of an emergency. In addition, the emergency response apparatus 102 can transmit current location information to the server 106 to be disseminated to the triage apparatus 114, mobile device 112, and the computer 110. The emergency response apparatus 102 also receives information via the network 104 regarding the condition of the one or more victims as well as any treatment administered to the victims by the first responders. The emergency response apparatus 102 also allows users, such as the emergency response personnel, to input observed conditions of the victims, treatments administered, observed weather, and other notes at an interface that are transmitted to the server 106.

The triage apparatus 114 is an external device, such as a Smart Phone, tablet, laptop, and the like, that is configured to receive triage information from the server 106 regarding the one or more victims being transported to the medical facility to receive care. The triage apparatus 114 can display a list of the one or more victims that includes approximate age, gender, injuries, approximate time of occurrence of the accident or emergency, a current status of treatment of the victims, and an estimated time of arrival (ETA) at the medical facility. Based on the information regarding the incoming patients to the medical facility, the medical personnel are able to prepare for the incoming victims, assign medical personnel to treat the victims before the victims arrive at the medical facility, and anticipate whether the medical facility will be able to accommodate the victims who are scheduled to arrive at the medical facility.

In some implementations, one or more medical professionals at the medical facility can confirm at the triage apparatus 114 that the medical facility has the capacity to accommodate the victim before the emergency vehicle transporting the victim is routed to the medical facility. In addition, the medical professionals at the medical facility can indicate at the triage apparatus 114 that the patient capacity of medical facility has exceeded a threshold based on number of patients, number of medical staff, expertise of the medical staff, and the like. If the patient capacity of the medical facility has been exceeded, the processing circuitry of the server 106 can determine another medical facility to transport the victim to, based on location, severity of injuries, and the like.

The computer 110 acts as a client device that is connected to the server 106, the database 108, the mobile device 112, the emergency response apparatus 102, and the triage apparatus 114 via the network 104. In some implementations, the computer 110 can be used by personnel at a central control center for an emergency medical service (EMS) that dispatches emergency medical personnel to the sites of one or more emergencies. The personnel at the central control center can input information at an interface at the computer 110 regarding the number of on-shift emergency vehicles and emergency medical personnel and can input manual routing information to the emergency vehicles. In certain embodiments, the personnel at the central control center can receive calls at the computer 110 from the mobile device 112 of the first responder.

The server 106 represents one or more servers connected to the computer 110, the database 108, the mobile device 112, the emergency response apparatus 102, and the triage apparatus 114 via the network 104. In some implementations, the processing circuitry of the server 106 receives emergency reports via the network 104 from one or more first responders related to emergencies that have occurred. The one or more first responders can report the emergency via an application at the mobile device 112 as will be discussed further herein. The emergency reports include information such as number of victims, location, time of occurrence, types of injuries, level of consciousness of the victims, amount of blood loss, and the like. Based on the location and severity of the injuries of the victims, the processing circuitry of the server 106 determines one or more emergency response teams to be routed to respond to the emergency by interfacing with the mobile device 112 of the first responder. In addition, the server 106 can output driving directions to the emergency response team via the emergency response apparatus 102 based on the GPS position of the emergency vehicle, traffic in route to the site of the emergency, weather, and the like. Details regarding the routing of the one or more emergency response vehicles to the emergencies will be discussed further herein.

The server 106 can also receive information input from the emergency response personnel via the emergency response apparatus 102 based on the injuries and current state of the victim, care administered to the victim, and the like. Based on the information received from the emergency response apparatus 102, the processing circuitry of the server 106 can determine a medical facility to transport the victim based on proximity of the medical facility to the scene of the emergency, current capacity of the medical facility, medical specialties of the medical facility, and the like by interfacing with the triage apparatus 114. For example, if a victim has been in a car accident and has suffered a major head trauma, the processing circuitry of the server 106, upon receiving the victim head trauma information, can determine that the victim should be transported to a hospital with a trauma center rather than a local medical center that may not specialize in head trauma injuries.

The processing circuitry of the server 106 also outputs triage information to the triage apparatus 114 so the medical personnel at the medical facility can review the information regarding the victims being transported to the medical facility such as estimated time of arrival, summary of the injuries, treatments received, and the like. For example, if three victims of a major car accident are being transported to a trauma hospital, the medical personnel at the trauma hospital can be alerted to the number of victims and types of injuries so that the medical personnel can assign surgeons, allocate operating rooms, and relocate current patients if necessary in order to accommodate the incoming patients.

The database 108 represents one or more databases connected to the computer 110, the server 106, the mobile device 112, the emergency response apparatus 102, and the triage apparatus 114 via the network 104. In certain embodiments, the database 108 can store information such as locations of emergency response facilities, such as city and county fire departments, number of emergency vehicles in service at each emergency response facility, profiles and qualifications of emergency response personnel employed by the emergency response facilities. In addition, the database 108 can store information regarding the medical facilities, such as number of staff members, number of beds, specialty treatment centers, qualifications and specialties of the physicians and nurses, and the like. The database 108 can also store one or more first aid videos that are viewed by the first responder at the mobile device 112 based on the injuries of the victim in order to assist the first responder with providing first aid to the victims before the emergency medical personnel arrive at the scene of the emergency. In some implementations, the database 108 can also store medical record information for one or more patients being treated at medical facilities within a location such as a city, county, state, province, country, or the like.

The mobile device 112 represents one or more mobile devices connected to the computer 110, the server 106, the database 108, the emergency response apparatus 102, and the triage apparatus 114 via the network 104. The mobile device 112 can include a Smart Phone, tablet, or any other wireless communication device that allows a user to send and receive information. In some implementations, a first responder at an emergency accesses an application on the mobile device 112 to input details regarding the emergency, number of victims, extent of the injuries, and the like, which is then transmitted to the server 106 to alert and route emergency medical personnel to the scene of the emergency. Based on the injuries of the victims input by the first responder at application on the mobile device 112, the first responder can view one or more videos that provide steps for administering first aid to the victims. For example, if the first responder indicates at the mobile device 112 that the victim has a compound fracture of the right femur, the first responder can view a video at the mobile device 112 that shows the first responder how to minimize bleeding and bandage the wound.

The network 104 represents one or more networks, such as the Internet, connecting the computer 110, the server 106, the database 108, the mobile device 112, the emergency response apparatus 102, and the triage apparatus 114. In certain embodiments, the emergency response apparatus 102 and triage apparatus 114 communicate wirelessly with the mobile device 112, database 108, server 106, and computer 110 via the network 104 that can include WI-FI, BLUETOOTH, cellular networks including EDGE, 3G and 4G wireless cellular systems, or any other wireless form of communication that is known.

As would be understood by one of ordinary skill in the art, based on the teachings herein, the mobile device 112 or any other external device could also be used in the same manner as the computer 110 to receive inputs from emergency response personnel, first responders, and medical staff working in emergency rooms. In addition, the emergency response apparatus 102 and the triage apparatus 114 can also be a mobile device, computer, or other external device. For example, an emergency medical technician can input victim vital signs, injuries, symptoms, and treatments at the emergency response apparatus, computer 110, or via an application on the mobile device 112. The information input at the computer 110 or mobile device 112 is received by the server 106 and is processed by processing circuitry of the server 106 to determine which medical facility to transport the victim to. The processing circuitry server 106 also determines routing directions for the emergency response vehicles based on traffic, weather, severity of the emergency, prior tasking of the emergency response vehicles, and the like. Details regarding the processes performed by the emergency response system 100 are discussed further herein.

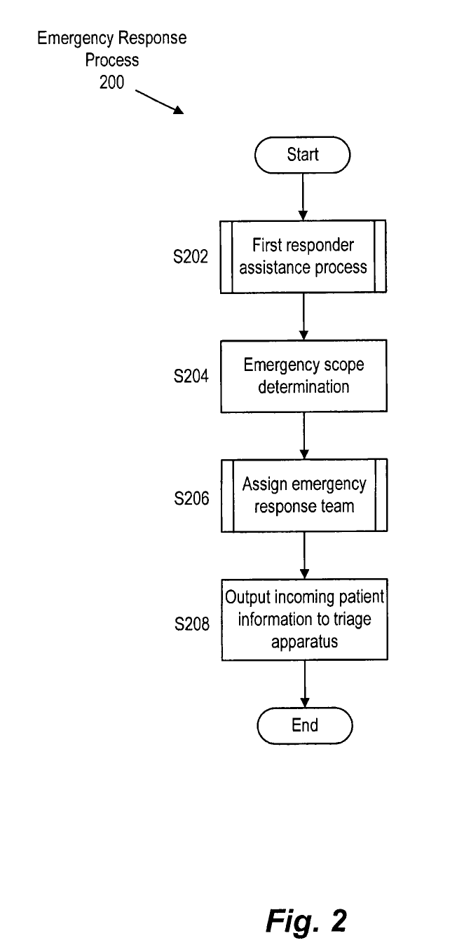

FIG. 2 is an exemplary flowchart of an emergency response process 200, according to certain embodiments. The emergency response process 200 commences with an emergency report by a user, such as the first responder, via an external device, such as the mobile device 112. For example, if a pedestrian is hit by a car while crossing a road at an intersection, the first responder may be another pedestrian who witnesses the accident. At step S202, a first responder assistance process is performed. The first responder can input an initial report via an application at the mobile device 112, which can include location of the emergency, number of victims, and types of injuries. In addition, the first responder can access videos and/or instructions that assist the first responder with administering first aid to the victim. Details regarding the first responder assistance process of step S202 are discussed further herein.

At step S204, an emergency scope determination is performed. In certain embodiments, the processing circuitry of the server 106 uses the information input by the first responder at the first responder assistance process of step S202 to determine the scope of an emergency situation based on one or more factors in order to provide an appropriate level of response to the emergency. Factors such as traffic, weather, remoteness of location, proximity of medical facilities to the scene of the emergency, and law enforcement events associated with the emergency can affect the number and expertise of emergency response teams that are dispatched to respond to the emergency. In certain embodiments, an emergency response team includes one or more emergency medical service personnel and an emergency response vehicle, such as an ambulance, fire truck, or helicopter. For example, a level of expertise of the emergency response team sent to respond to a victim with a heart attack in a suburban home with a hospital located one mile away from the site of the emergency may be lower than the level of expertise of the emergency response team sent to respond to a victim with gunshot wounds in an active shooter scenario.

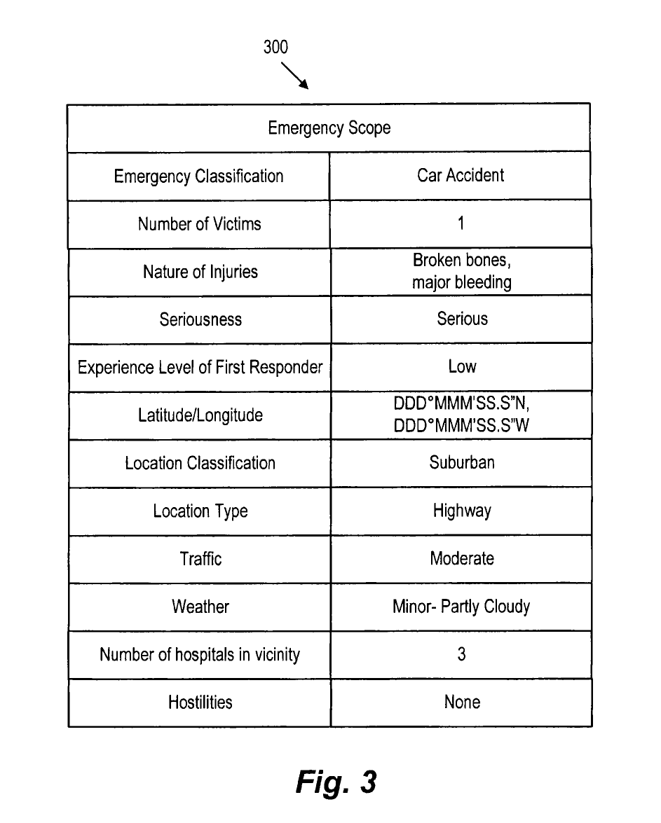

FIG. 3 is an exemplary illustration of factors affecting the emergency scope 300 determination of step S204, according to certain embodiments. The emergency scope 300 gives a snapshot summary of the emergency reported by the first responder at the mobile device 112 to ensure that the appropriate level of response to emergencies is provided by the emergency response system 100. The emergency scope 300 can include factors such as an emergency classification, number of victims, nature of injuries, severity level, experience level of first responder, latitude/longitude, location classification, location type, amount of traffic and weather in the vicinity of the emergency, number of hospitals within a predetermined distance of the emergency, and any type of hostilities in the vicinity of the emergency.

The emergency classification of the emergency scope 300 includes a categorical descriptor of the emergency, such as car accident, shooting, in-home medical event, such as a heart attack, and the like. The number of victims is based on the number of victims reported by the first responder at the mobile device 112 at step S202. The nature of the injuries can include a list of the type of injuries suffered by the victim, and a severity level, such as stable, serious, or critical, indicates a level of urgency of response associated with the injuries. For example, the serious severity level can indicate that victim is suffering from one or more injuries, such as a heart attack or severe bleeding that may require immediate medical attention. In some implementations, the critical severity level can indicate that the patient is unconscious, not breathing, and/or death appears to be imminent.

In some implementations, the first responder can indicate a level of medical expertise at the emergency reporting application on the mobile device 112, which can be used by the processing circuitry to determine a level of urgency of response by the emergency response teams. For example, a first responder with a low level of medical expertise may not be qualified to perform cardiopulmonary resuscitation (CPR) on a victim who is not breathing and has an absent pulse, so the level of urgency of response may be higher than the level of urgency of response where the first responder is a nurse or physician who is qualified to perform CPR and administer first aid.

The location of the emergency can include latitude and longitude of the mobile device 112 where the emergency report originated based on the location determined by the GPS receiver of the mobile device 112. In some implementations, when the first responder manually inputs an approximate location of the emergency at the mobile device 112 by indicating a zip code, city, neighborhood, and the like, the processing circuitry of the server 106 determines the location of the emergency as a central point of the location input by the first responder. Based on the location of the mobile device 112, the processing circuitry of the server 106 can determine a location classification for the emergency, such as urban, suburban, rural, remote, and the like. The processing circuitry can also determine the location type such as a highway, residence, or shopping mall as well as the amount of traffic in the vicinity of the emergency based on one or more real-time traffic reports. For example, the amount of traffic can be designated as light, moderate, or heavy based on an average speed of vehicles compared to the speed limit, traffic hazards, construction, and the like. In some implementations, the location classification, location type, and amount of traffic can be manually input by the first responder at the mobile device 112.

In addition, the location of the emergency can be used by the processing circuitry of the server 106 to determine the weather in the vicinity of the emergency based on one or more weather reports. The first responder can also manually input observed weather conditions at the mobile device 112. The location of the emergency can be used by the processing circuitry to determine how many hospitals are within a predetermined distance of the emergency. In an implementation, the predetermined distance can be set to half a mile, one mile, five miles, ten miles, twenty miles or any distance based on remoteness of location. In certain embodiments, the processing circuitry of the server 106 can output a predetermined number of the closest hospitals or medical facilities to the location of the emergency.

The processing circuitry of the server 106 can also use the location of the emergency to determine if any hostilities that may have been reported are occurring at the approximate location of the emergency by interfacing with law enforcement dispatch servers and servers of other emergency response agencies and systems. For example, if the emergency report indicates that the victim has suffered from a gunshot wound and the law enforcement dispatch service has received a report of an active shooter at a location that is within a predetermined distance of the location of the emergency, the emergency scope can indicate details of the active shooter situation. The first responder can also manually input hostility information at the mobile device 112.

Referring back to FIG. 2, at step S206, emergency response teams are assigned to respond to the emergency reported by the first responder at step S202 based on the emergency scope determination of step S204. In some implementations, the emergency response teams are assigned to a corresponding emergency vehicle, such as an ambulance, that has an emergency response apparatus 102 installed in the vehicle. Once the emergency response team is assigned to respond to the emergency, the server 106 can transmit driving directions to a driver of the emergency vehicle via the network 104 and the emergency response apparatus 102. Details of the assignment of the emergency response teams are discussed further herein.

At step S208, the processing circuitry of the server 106 outputs incoming patient information to the triage apparatus 114. The incoming patient information can be based on information input by the first responder at the mobile device 112 or by the emergency response personnel at the emergency response apparatus 102. In some implementations, the incoming patient information displayed at the triage apparatus 114 can assist medical personnel in hospital emergency rooms with preparations for the incoming patients. For example, if an emergency room has three incoming patients and only two beds available in the emergency room, the medical personnel at the hospital can make arrangements to move a patient to another area of the hospital to ensure that there is room for the three incoming patients. In addition, if an incoming patient has a life-threatening condition that may require surgery, the medical personnel at the hospital can make arrangements to prepare an operating room and alert one or more surgeons who may perform the surgery. The medical personnel of the hospital can also provide input at an interface of the triage apparatus 114 regarding number and type of available medical staff members during one or more shifts at the hospital, expertise areas of the available medical staff members during the one or more shifts, current capacity of the emergency room, and the like.

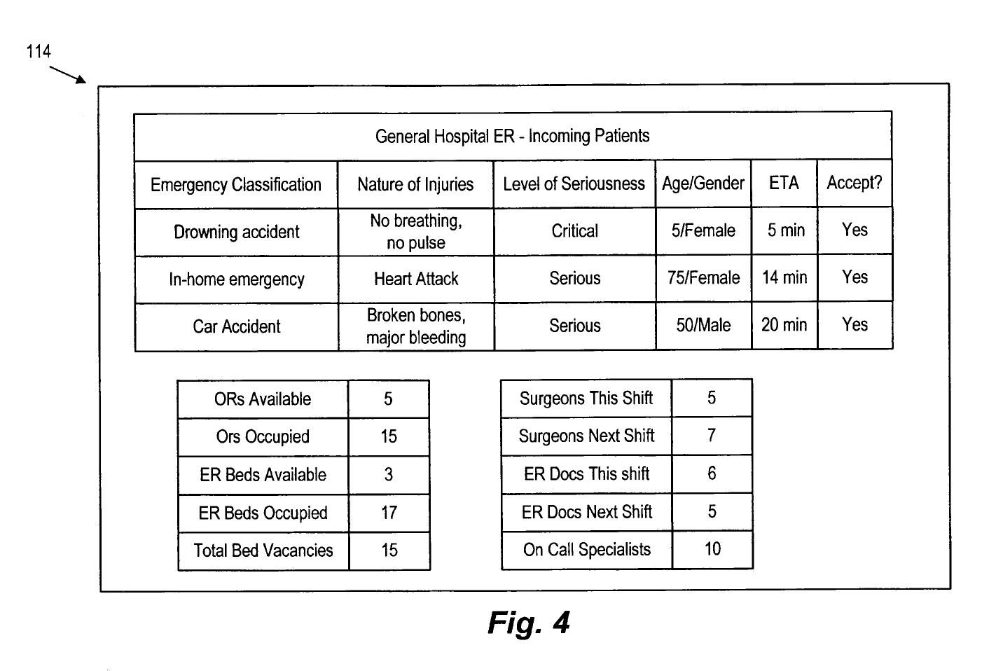

FIG. 4 is an exemplary illustration of a display of the triage apparatus 114, according to certain embodiments. The triage apparatus 114 allows medical personnel at hospitals prepare for incoming patients by providing details regarding a current condition of the incoming patients. For example, once the processing circuitry of the server 106 assigns a victim to a hospital or medical facility to receive care, the victim is referred to as an incoming patient for the hospital. The triage apparatus 114 displays information such as emergency classification, nature of injuries, severity level, age, gender, and ETA for the incoming patients. In some implementations, the triage apparatus 114 can also display vital signs of the incoming patients, such as blood pressure, pulse, and temperature that are sent from the emergency response apparatus 102.

The triage apparatus 114 can also include a time to return to a treatment area, such as the emergency room or operating room, for the medical professionals assigned to treat the incoming patients that is set to a predetermined time before the ETA of the incoming patient to the hospital. For example, the time to return can be set to five minutes before the ETA of the incoming patient. In some implementations, the processing circuitry of the server 106 can output a text message or alarm to the mobile device 112 of one or more medical staff members to alert the medical staff members of the time to return to the emergency room or operating room.

In some implementations, the triage apparatus 114 allows the staff of the hospital to provide input to the server 106 regarding whether the hospital is able to accept incoming patients due to capacity of the hospital, staffing shortages, and the like. For example, for each incoming patient assigned to the hospital, the medical staff can accept or reject the incoming patient by via a dropdown menu or radio button at the interface of the triage apparatus 114. If the medical staff rejects the incoming patient, the processing circuitry of the server 106 can determine an alternate medical facility for the incoming patient, if possible. In some implementations where there may not be an alternate medical facility for the incoming patient, such as during large-scale natural disasters where there may be hundreds of victims, the server 106 can notify the medical staff of the hospital via the triage apparatus 114 that there are no alternate medical facilities available.

The display of the triage apparatus 114 can also include bed capacity data, which can include a number of available beds and total beds in departments of the hospital, such as the operating room, emergency room, and other departments of the hospital. In some implementations, a percentage of total occupancy for the departments of the hospital is included. In addition, the display of the triage apparatus 114 includes provider capacity data, which can include a number of on-shift surgeons, emergency room physicians, and other medical specialists as well as a number of medical personnel assigned to the next shift.

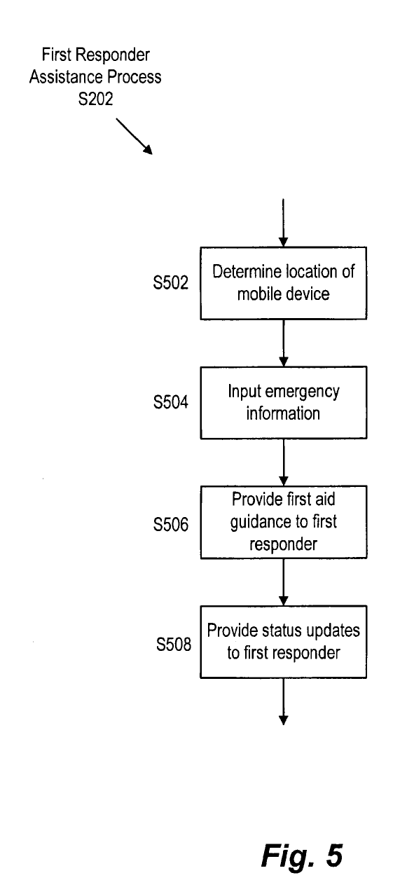

FIG. 5 is an exemplary flowchart of the first responder assistance process of step S202, according to certain embodiments. At step S502, when the first responder opens the emergency reporting application on the mobile device 112 to report the emergency, the processing circuitry of the server 106 determines the location of the mobile device 112. In some implementations, the location of the mobile device 112 is determined based on a location determined by positioning systems installed in the mobile device, such as a GPS receiver. However, the location of the mobile device 112 can also be determined based on location information input by the first responder, such as a zip code, city, neighborhood, road intersection and the like. Once the location of the mobile device 112 has been determined, the first responder can be asked by a screen in the emergency reporting application to confirm that the determined location is the site of an emergency medical situation.

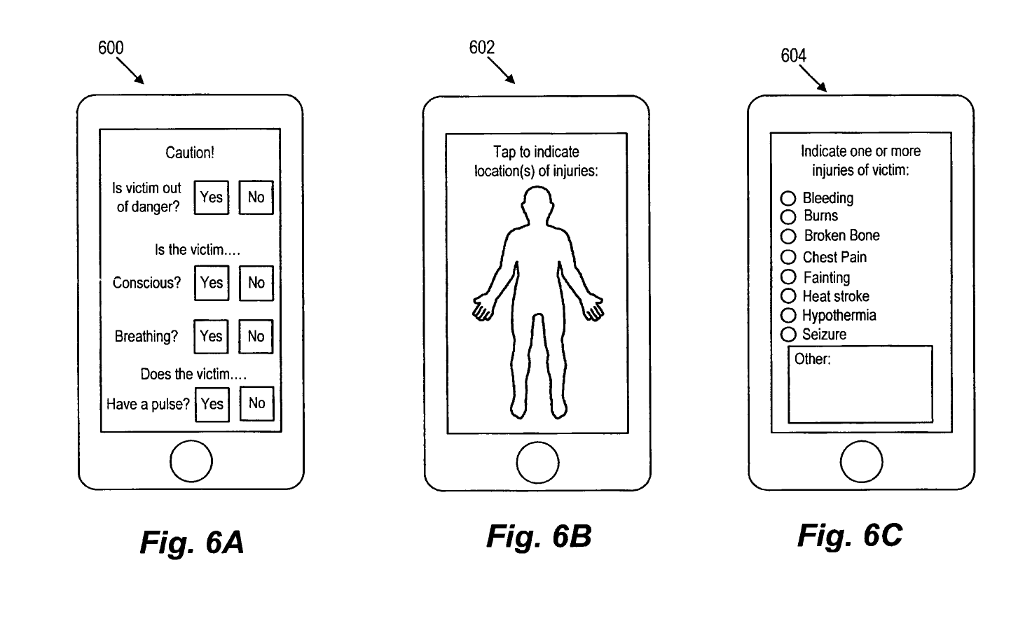

At step S504, the first responder inputs details of the emergency at the emergency reporting application on the mobile device 112. FIGS. 6A-6C illustrate screens on the mobile device 112 for the first responder to input the emergency information, according to certain embodiments. FIG. 6A is an illustration of an exemplary initial screen 600 of the emergency reporting application on the mobile device 112 for inputting one or more symptoms. In some implementations, the initial screen 600 includes one or more conditions and/or symptoms of the victim that may be most important for the first responder to check to ensure that the victim is given adequate care. For example, the first responder can indicate at the initial screen 600 whether the victim is out of immediate danger, such as away from a busy road or sheltered from extreme weather conditions. In addition, the first responder can indicate whether the victim is conscious, is breathing, or has a pulse. In some aspects, if the first responder indicates that the victim is unconscious, not breathing, or without a pulse, the severity level of the injuries indicated by the emergency scope 300 is set to critical.

FIG. 6B is an illustration of an exemplary injury location screen 602 of the emergency reporting application on the mobile device 112 that allows the first responder to indicate one or more relative locations of injuries on the body of the victim, according to certain embodiments. For example, if the victim is suffering from a pneumothorax injury, the first responder would tap a chest area of an exemplary body on the injury location screen 602. In some implementations, the severity level of the injuries indicate by the emergency scope 300 is based on the location of injuries reported at the injury location screen 602. For example, injuries of the head, chest, or neck may be assigned a severity level that is higher than the severity level assigned to extremities of the body, such as toes or hands.

FIG. 6C is an illustration of an exemplary injury list screen 604 of the emergency reporting application on the mobile device 112 that allows the first responder to annotate the injuries of the victim, according to certain embodiments. For example, the first responder scrolls through lists of injuries on the injury list screen 604 organized alphabetically or by injury category and identifies the injuries that the victim is suffering from. The injury list screen 604 can also include a search feature where the first responder can input an injury, and the processing circuitry will output one or more related results. In some implementations, the processing circuitry of the server 106 identifies one or more of the most likely injuries based on the locations of the injuries indicated at the injury location screen 602. The injury list screen 604 can also include a free text section where the first responder can add injuries that are not included on the injury list screen 604 or other amplifying comments.

The emergency reporting application on the mobile device 112 can also include additional screens that allow the first responder to portray the scene of the emergency and an extent of the injuries of the victim. For example, the emergency reporting application can include screens where the first responder indicates the observed traffic and/or weather in the surrounding area as well as hostilities in the surrounding area.

Referring back to FIG. 5, at step S506, guidance is provided to the first responder regarding how to administer first aid to the victim. The guidance provided to the first responder can include videos, audio files, checklists, and the like that illustrate steps for the first responder to take to place the victim in a safe location while taking steps to mitigate effects of the injury and/or illness. Based on the injuries of the victim reported at step S504, the processing circuitry of the server 106 can determine a priority of steps for the first responder to take. For example, if the victim is unconscious, not breathing, and has a leg wound, the emergency reporting application on the mobile device 112 can alert the first responder to take steps to restore breathing before addressing the leg wound. In addition, the first responder can indicate at the mobile device 112 that he or she has accomplished one or more of the steps of the first aid guidance provided to the first responder. The one or more first aid steps accomplished by the first responder are then transmitted by the server 106 via the network 104 to the emergency response apparatus 102 of the emergency response team that is dispatched to the scene of the emergency.

In some implementations, the guidance provided to the first responder can also include videos and/or checklists of actions to avoid so that the first responder avoids putting the victim in additional danger. For example, if the victim is suffering from a seizure, the emergency reporting application on the mobile device 112 can alert the first responder to avoid attempting to restrain the victim and to avoid placing objects in the victim's mouth. In addition, the emergency reporting application can alert the first responder to avoid leaving the victim unattended until the emergency response team arrives.

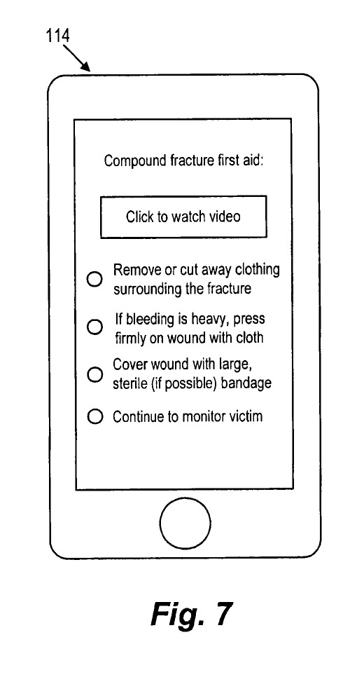

FIG. 7 is an illustration of an exemplary instructional screen 700 providing first aid guidance to the first responder regarding steps to take to care for a victim with a compound fracture, according to certain embodiments. For example, the instructional screen includes a button for the first responder to select to view a video that explains how to assist a victim with a compound fracture. In some implementations, the instructional screen 700 allows the first responder to access an audio file if the environment of the emergency is not convenient for viewing a video.

The instructional screen 700 also includes a list of the one or more steps for the first responder to perform while caring for the victim with the compound fracture that include removing clothing surrounding the fracture, minimizing heavy bleeding by applying pressure to the wound with a cloth, covering the wound with a bandage, and continuing to monitor the victim for signs of stress. In some implementations, the first responder can indicate when he or she has completed a step on the instructional screen 700 which is then transmitted to the server 106. Information regarding the first aid steps performed by the first responder can then be provided to the emergency response apparatus 102 and the triage apparatus 114, according to certain embodiments.

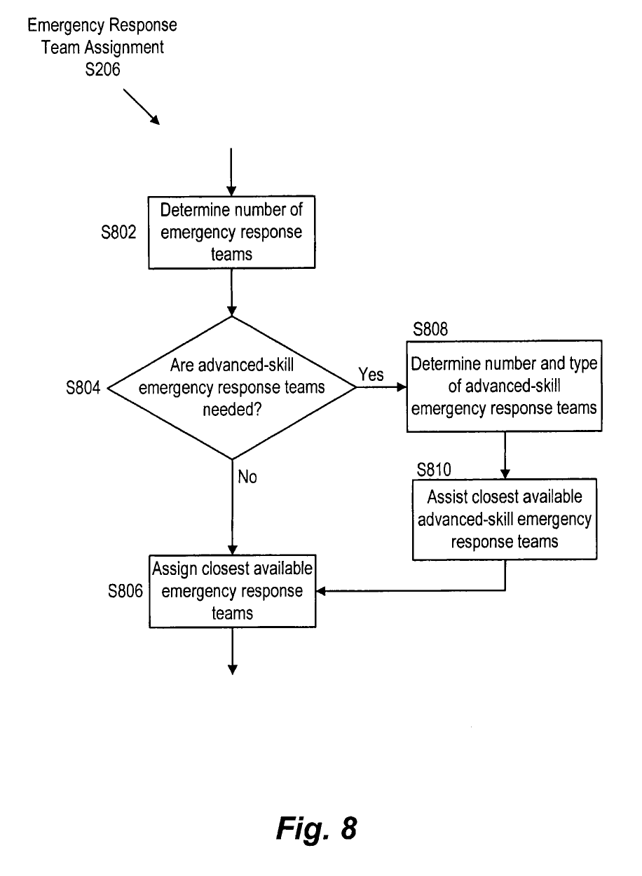

FIG. 8 is an exemplary flowchart of an emergency response team assignment of step S206, according to certain embodiments. At step S802, a number of emergency response teams that may be required to respond to the emergency are determined. In some implementations, the number of emergency response teams that are determined is based on the number of victims of the emergency and a severity level of the injuries of the victims. For example, in some aspects, if the number of victims in an emergency reported by the first responder at the mobile device 112 is greater than one and the severity level of the injuries is high for at least one of the victims, then one emergency response team per victim may be dispatched to the scene of the emergency. In addition, if the number of victims is between one and three and the level of severity of the injuries is low for all of the victims, then only one emergency response team may be dispatched to the scene of the emergency. In some implementations, the thresholds of number of victims and severity of injuries used by the processing circuitry of the server 106 to determine the number of emergency response teams to dispatch to the scene of the emergency can vary based on the number of on-shift emergency response teams within a predetermined radius of the emergency, the number of active emergencies within the predetermined radius, and the like.

At step S804, the processing circuitry of the server 106 determines whether advanced-skill emergency response teams may be needed to respond to the emergency based on the emergency scope determination of step S204. In some implementations, advanced-skill emergency response teams have one or more specialized skills related to emergency response and/or law enforcement. For example, if the emergency scope includes that the location of the emergency is at a remote campsite in the woods of a mountain that is inaccessible by car, then an advanced-skill emergency response team that responds to emergencies by helicopter may be dispatched to the scene of the emergency. In addition, if the emergency scope includes that there is an active shooter at the scene of the emergency, then law enforcement personnel may be alerted to respond to the casualty. If it is determined that no advanced-skill emergency response teams are needed to respond to the emergency, resulting in a “no” at step S804, then step S806 is performed. Otherwise, if it is determined that at least one advanced-skill emergency response team may be needed to respond to the emergency, resulting in a “yes” at step S804, then step S808 is performed.

At step S806, the number of emergency response teams determined at step S802 is assigned to respond to the emergency based on current location and availability of the on-shift emergency response teams. For example, if it is determined at step S802 that two emergency response teams may be needed to respond to an emergency, then the two closest emergency response teams that have not been assigned to other tasks are assigned to respond to the emergency. In some implementations, factors such as traffic and weather can affect the emergency response teams that are assigned to respond to the emergency. For example, the processing circuitry can assign the emergency response teams with a shortest driving time based on traffic and weather conditions for the available emergency response teams.

The sever 106 then outputs a dispatch order to the emergency response apparatus 102 of the emergency response teams assigned to respond to the emergency. The dispatch order can include a map of the area surrounding the emergency, navigation instructions to the location of the emergency, summary of the injuries and status of the victims, and the like. For emergencies with one or more advanced-skill emergency response teams assigned to respond to the emergency, the number of emergency response teams assigned at step S806 is equal to the number of emergency response teams determined at step S802 minus the number of advanced-skill emergency response teams assigned at step S810.

If the determination is made at step S804 that advanced-skill emergency response teams may be required to respond to the emergency, then at step S808, the processing circuitry determines a number and type of advanced-skill emergency response teams to assign emergency response. For example, if the emergency report from the mobile device 112 of the first responder indicates that the victim may have overdosed on one or more narcotics, then the processing circuitry may determine that an emergency response team with experience dealing with narcotics emergencies may be needed. In addition, the processing circuitry of the server 106 may also determine based on the emergency scope determined at step S204 that other emergency response personnel, such as law enforcement, firefighters, and the like, may be needed to respond to the emergency. In some implementations, the server 106 outputs requests for other emergency response personnel to the computer 110 at the central control center so that the appropriate agencies can be notified.

At step S810, the number and type of advanced-skill emergency response teams determined at step S808 are assigned to respond to the emergency based on current location and availability of the on-shift emergency response teams. For example, if the emergency reported includes a car accident where one or more victims are trapped in a damaged vehicle, one or more emergency response teams who have equipment for disassembling a vehicle, such as Jaws of Life, may be assigned to respond to the emergency. The sever 106 then outputs a dispatch order to the emergency response apparatus 102 of the emergency response teams assigned to respond to the emergency. The dispatch order can include a map of the area surrounding the emergency, driving directions to the location of the emergency, summary of the injuries and status of the victims, and the like.

Responding to medical emergencies can be stressful for first responders, emergency medical personnel, and medical staff members at hospitals due to the nature of the victim's injuries. In some medical emergencies, providing prompt medical attention can be the difference between life and death of the patient. The emergency response system 100 allows information from the scene of the emergency to be disseminated to the central control center, medical facilities, and emergency response teams so that all parties involved with responding to the emergency are as prepared as possible to provide timely care to the victim.

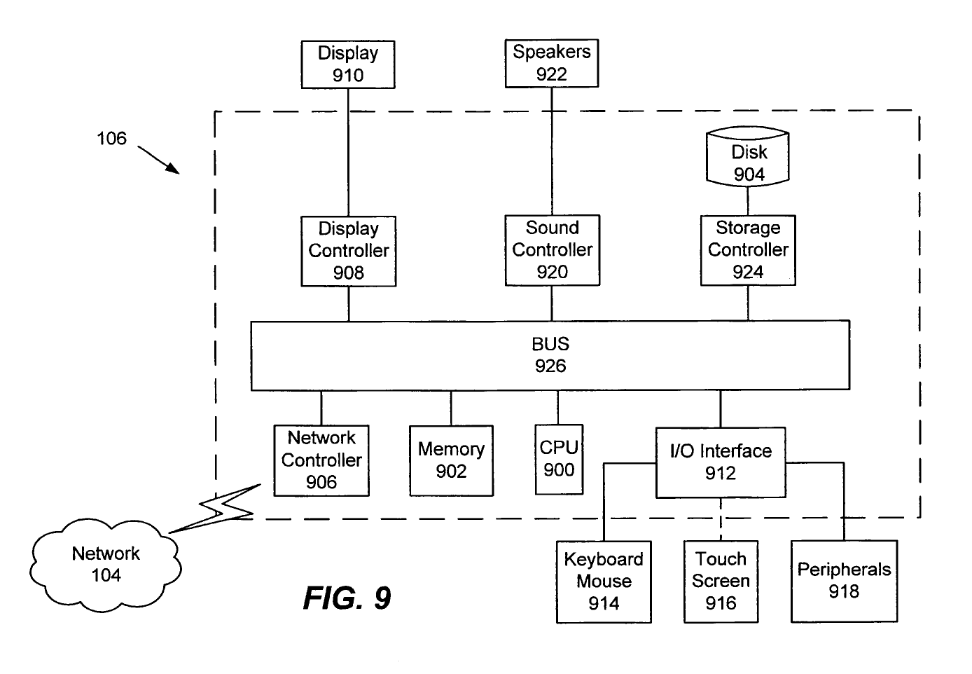

A hardware description of the server 106 according to exemplary embodiments is described with reference to FIG. 9. In addition, the hardware described by FIG. 9 can also apply to the emergency response apparatus 102, the triage apparatus 114, and the mobile device 112. Implementation of the processes of the emergency response system 100 on the hardware described herein improves the speed and accuracy of reporting, processing, and responding to medical emergencies. The server 106 includes a CPU 900 that perform the processes described herein. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 106 communicates, such as the computer 110.

Further, the claimed advancements may be provided as a utility application, background daemon, or component of an operating system, or combination thereof, executing in conjunction with CPU 900 and an operating system such as Microsoft Windows 7, UNIX, Solaris, LINUX, Apple MAC-OS and other systems known to those skilled in the art.

CPU 900 may be a Xenon or Core processor from Intel of America or an Opteron processor from AMD of America, or may be other processor types that would be recognized by one of ordinary skill in the art. Alternatively, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the inventive processes described above.

The server 106 in FIG. 8 also includes a network controller 906, such as an Intel Ethernet PRO network interface card from Intel Corporation of America, for interfacing with network 104. As can be appreciated, the network 104 can be a public network, such as the Internet, or a private network such as an LAN or WAN network, or any combination thereof and can also include PSTN or ISDN sub-networks. The network 104 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The server 106 further includes a display controller 908, such as a NVIDIA GeForce GTX or Quadro graphics adaptor from NVIDIA Corporation of America for interfacing with display 910 of the emergency response apparatus 102 and the triage apparatus 114, such as a Hewlett Packard HPL2445w LCD monitor. A general purpose I/O interface 912 at the server 106 interfaces with a keyboard and/or mouse 914 as well as a touch screen panel 916 on or separate from display 910. General purpose I/O interface 912 also connects to a variety of peripherals 818 including printers and scanners, such as an OfficeJet or DeskJet from Hewlett Packard.

A sound controller 920 is also provided in the server 106, such as Sound Blaster X-Fi Titanium from Creative, to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the server 106. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

In other alternate embodiments, processing features according to the present disclosure may be implemented and commercialized as hardware, a software solution, or a combination thereof. Moreover, instructions corresponding to the emergency response process 200 in accordance with the present disclosure could be stored in a thumb drive that hosts a secure process.

A number of implementations have been described. Nevertheless, it will be understood that various modifications may be made without departing from the spirit and scope of this disclosure. For example, preferable results may be achieved if the steps of the disclosed techniques were performed in a different sequence, if components in the disclosed systems were combined in a different manner, or if the components were replaced or supplemented by other components. The functions, processes and algorithms described herein may be performed in hardware or software executed by hardware, including computer processors and/or programmable circuits configured to execute program code and/or computer instructions to execute the functions, processes and algorithms described herein. Additionally, an implementation may be performed on modules or hardware not identical to those described. Accordingly, other implementations are within the scope that may be claimed.

The above disclosure also encompasses the embodiments listed below.

(1) An emergency response system, including: at least one server with circuitry configured to receive, from an external device, an emergency report describing injuries of at least one victim, determine a scope of an emergency based on the emergency report describing a location of the at least one victim and the injuries of the at least one victim, output, to the external device, instructions related to providing first aid based on the injuries of the at least one victim, assign at least one emergency response team to respond to the emergency, and output information related to one or more incoming patients to a medical facility.

(2) The system of (1), wherein the circuitry is further configured to determine the location of the at least one victim based on a location of the external device transmitting the emergency report.

(3) The system of (1) or (2), wherein the circuitry is configured to output navigational instructions to the at least one emergency response team based on the location of the at least one victim.

(4) The system of any one of (1) to (3), wherein the circuitry is further configured to receive a level of medical expertise of a user of the external device.

(5) The system of any one of (1) to (4), wherein the circuitry is further configured to modify the instructions output to the external device based on the level of medical expertise of the user.

(6) The system of any one of (1) to (5), wherein the circuitry is further configured to determine a severity level of the injuries based on a number of victims and one or more types of injuries.

(7) The system of any one of (1) to (6), wherein the circuitry is further configured to determine the severity level based on locations of the injuries on the at least one victim.

(8) The system of any one of (1) to (7), wherein the circuitry is further configured to increase the severity level of the at least one victim when the locations of the injuries are at at least one of a head, chest, and neck.

(9) The system of any one of (1) to (8), wherein the circuitry is further configured to determine that the injuries of the at least one victim have the severity level of critical when the at least one victim is at least one of unconscious, not breathing, or without a pulse.

(10) The system of any one of (1) to (9), wherein the circuitry is further configured to determine a number of emergency response teams to assign to the emergency based on a severity level of the injuries.

(11) The system of any one of (1) to (10), wherein the circuitry is further configured to assign at least one advanced-skill emergency response team based on one or more factors of the scope of the emergency.

(12) The system of any one of (1) to (11), wherein the instructions output to the external device include one or more steps to avoid when caring for the at least one victim based on the injuries of the at least one victim.

(13) The system of any one of (1) to (12), wherein the circuitry is further configured to transmit an estimated time of arrival of the one or more incoming patients to the medical facility based on information received from the emergency response team.

(14) The system of any one of (1) to (13), wherein the circuitry is further configured to output to the medical facility a time to return to a treatment area for one or more medical staff based on the estimated time of arrival of the one or more incoming patients.

(15) The system of any one of (1) to (14), wherein the circuitry is further configured to determine available resources of one or more medical facilities and to assign the one or more incoming patients to a specific medical facility based on the available resources.

(16) The system of any one of (1) to (15), wherein the circuitry if further configured to, in response to receiving a rejection of the one or more incoming patients from the medical facility and based on injuries of the one or more incoming patients, determine a next closest medical facility.

(17) The system any one of (1) to (16), wherein the circuitry is further configured to reassign the one or more incoming patients that are rejected from the medical facility further based on a lack of available resources of the medical facility.

(18) The system of any one of (1) to (17), wherein the circuitry is further assign the at least one emergency response team with a shortest driving time based on at least one of traffic, weather, and the location of the at least one victim.

(19) A method for emergency response, including: receiving, from an external device, an emergency report describing injuries of at least one victim; determining, at at least one server, a scope of an emergency based on the emergency report describing a location of the at least one victim and the injuries of the at least one victim; outputting, to the external device, instructions related to providing first aid based on the injuries of the at least one victim; assigning, via the at least one server, at least one emergency response team to respond to the emergency; and outputting information, from the at least one server, related to one or more incoming patients to a medical facility.

(20) A non-transitory computer-readable medium having computer-readable instructions thereon which when executed by a computer cause the computer to perform a method for emergency response, the method including: receiving an emergency report describing injuries of at least one victim; determining a scope of an emergency based on the emergency report describing a location of the at least one victim and the injuries of the at least one victim; outputting instructions related to providing first aid based on the injuries of the at least one victim; assigning at least one emergency response team to respond to the emergency; and outputting information related to one or more incoming patients to a medical facility.

1. An emergency response system, comprising:
at least one server with circuitry configured to
receive, from an external device, an emergency report describing injuries of at least one victim,
determine a scope of an emergency based on the emergency report describing a location of the at least one victim and the injuries of the at least one victim,
output, to the external device, instructions related to providing first aid based on the injuries of the at least one victim,
assign at least one emergency response team to respond to the emergency, and
output information related to one or more incoming patients to a medical facility.

2. The system of claim 1, wherein the circuitry is further configured to determine the location of the at least one victim based on a location of the external device transmitting the emergency report.

3. The system of claim 2, wherein the circuitry is configured to output navigational instructions to the at least one emergency response team based on the location of the at least one victim.

4. The system of claim 1, wherein the circuitry is further configured to receive a level of medical expertise of a user of the external device.

5. The system of claim 3, wherein the circuitry is further configured to modify the instructions output to the external device based on the level of medical expertise of the user.

6. The system of claim 1, wherein the circuitry is further configured to determine a severity level of the injuries based on a number of victims and one or more types of injuries.

7. The system of claim 6, wherein the circuitry is further configured to determine the severity level based on locations of the injuries on the at least one victim.

8. The system of claim 7, wherein the circuitry is further configured to increase the severity level of the at least one victim when the locations of the injuries are at at least one of a head, chest, and neck.

9. The system of claim 5, wherein the circuitry is further configured to determine that the injuries of the at least one victim have the severity level of critical when the at least one victim is at least one of unconscious, not breathing, or without a pulse.

10. The system of claim 1, wherein the circuitry is further configured to determine a number of emergency response teams to assign to the emergency based on a severity level of the injuries.

11. The system of claim 1, wherein the circuitry is further configured to assign at least one advanced-skill emergency response team based on one or more factors of the scope of the emergency.

12. The system of claim 1, wherein the instructions output to the external device include one or more steps to avoid when caring for the at least one victim based on the injuries of the at least one victim.

13. The system of claim 1, wherein the circuitry is further configured to transmit an estimated time of arrival of the one or more incoming patients to the medical facility based on information received from the emergency response team.

14. The system of claim 13, wherein the circuitry is further configured to output to the medical facility a time to return to a treatment area for one or more medical staff based on the estimated time of arrival of the one or more incoming patients.

15. The system of claim 1, wherein the circuitry is further configured to determine available resources of one or more medical facilities and to assign the one or more incoming patients to a specific medical facility based on the available resources.

16. The system of claim 1, wherein the circuitry if further configured to, in response to receiving a rejection of the one or more incoming patients from the medical facility and based on injuries of the one or more incoming patients, determine a next closest medical facility.

17. The system of claim 16, wherein the circuitry is further configured to reassign the one or more incoming patients that are rejected from the medical facility further based on a lack of available resources of the medical facility.

18. The system of claim 1, wherein the circuitry is further assign the at least one emergency response team with a shortest driving time based on at least one of traffic, weather, and the location of the at least one victim.

19. A method for emergency response, comprising:
receiving, from an external device, an emergency report describing injuries of at least one victim;
determining, at at least one server, a scope of an emergency based on the emergency report describing a location of the at least one victim and the injuries of the at least one victim;
outputting, to the external device, instructions related to providing first aid based on the injuries of the at least one victim;
assigning, via the at least one server, at least one emergency response team to respond to the emergency; and
outputting information, from the at least one server, related to one or more incoming patients to a medical facility.

20. A non-transitory computer-readable medium having computer-readable instructions thereon which when executed by a computer cause the computer to perform a method for emergency response, the method comprising:
receiving an emergency report describing injuries of at least one victim;
determining a scope of an emergency based on the emergency report describing a location of the at least one victim and the injuries of the at least one victim;
outputting instructions related to providing first aid based on the injuries of the at least one victim;
assigning at least one emergency response team to respond to the emergency; and
outputting information related to one or more incoming patients to a medical facility.
